(19) United States
(12) Patent Application Publication
(10) Pub. No.: US 2003/0011252 A1
(43) Pub. Date: Jan. 16, 2003

(54) ROTO-OSCILLATOR

(76) Inventor: Edwin Langberg, Medford, NJ (US)

Correspondence Address: EDWIN LANGBERG, 56 BRIDGE ROAD, MEDFORD, NJ, 08055

(21) Appl. No.: 09/905,729

(22) Filed: Jul. 14, 2001

(51) Int. Cl. H02K 33/00; H02K 35/00

(52) U.S. Cl. 310/36

(57) ABSTRACT

A roto-oscillator and a velocity-sensing driver producing vibrotactile skin stimulation are disclosed. Driver current flowing through a coil produces a magnetic field that interacts with a roto-oscillating permanent magnet. Shaft supported and shaft-less embodiments are disclosed. Spring linkages are used to constrain the unenergized angular position of the roto-oscillating permanent magnet with respect to the coil current-induced magnetic field, such as to substantially optimize a vibratory torque generation. Spring linkages further serve to store the kinetic energy of roto-oscillation and to determine the optimum frequency of oscillation and the direction of vibrotactile stimulus. A velocity sensing circuit is used to provide a feedback signal for the roto-oscillator driver.

This invention was made with Government support under a grant awarded by the National Institutes of Health. The Government has certain rights in this invention.

### BACKGROUND OF THE INVENTION

This invention relates generally to the field of transducers converting an electrical input to a mechanical vibration and using thus generated vibration for excitation of a tactile stimulus. Specifically, the invention relates to electromechanical rotational oscillation transducers directly or indirectly coupled to the skin.

One use of such transducers is for on/off signaling devices, e.g., in “silent alarms” in cellular phones and pagers. Another use, more specifically related to this invention, is a method and apparatus for producing a distinct variation of amplitude, frequency, and duration of a tactile stimulus usable for continuous broadband tactile communication, e.g., for the hearing impaired. Tactile communication systems are also used when sight and hearing senses may be overloaded with information, e.g., in the case of military aircraft pilots.

Representative of prior art is U.S. Pat. No. 5,388,992 by Franklin et al. issued on Feb. 14, 1995, proposing the use of small direct current (dc) motors or stepper motors to create an alternating rotational movement to generate a tactile response. There are a number of problems associated with this approach:

(a) Oscillating motion in vibrotactile stimulation dissipates only a fraction of its kinetic energy into skin stimulation. In the transducer based on Franklin's patent, this leftover kinetic energy is dissipated twice every cycle by a braking action of the motor. The result is low efficiency and excessive heating of the transducer. Vibrotactile transducers are typically portable and battery operated and so power efficiency is an important consideration determining the time of operation between battery changes or charges.

(b) An inherent part of a dc motor is a rotating commutator and contacting stationary brushes transferring current from the motor driver to rotating coils. Contact life between the commutator and the brushes severely limits the driving current. Commutator electrical contact resistance and friction adds to power losses and heating. A commutator is in general susceptible to damage affecting the survival life, especially in portable applications. Yet, tactile communication devices must be capable of reliable and extended continuous operation. . The transient response of a small dc motor is typically longer than 100 ms, severely restricting its usefulness for oscillatory operation in a frequency region between 100 Hz and 400 Hz corresponding to optimum sensitivity of the skin to vibrotactile stimulation. Further, the transient response of a dc motor depends on the commutator position at the time of the driving pulse application. Since this position is uncontrolled, the dynamic response has a random component.

(c) A stepper motor, as the name implies, is designed to rotate effectively in discrete steps. The minimum amplitude of oscillation of the rotor is therefore equal to one step. This quantization of amplitude seriously limits the nuances of amplitude modulation desirable in a broadband tactile communication transducer.

A variety of known drivers can be used to operate dc stepper motors or for that matter the roto-oscillators of this invention. If a single power supply and a purely sinusoidal operation are required, one can for example use two linear amplifiers with the roto-oscillator connected between their outputs. Normally, non-sinusoidal distortion can be readily tolerated in vibrotactile transducers and in this case a dual full-bridge pulse-width modulator driver is a power efficient alternative. Such drivers, fully integrated for low voltage motors, are commercially available. However, an improvement of tactile communication parameters can be better served by the specialized drivers of this invention.

For reasons discussed above, the present state of the art of vibrotactile electro-mechanical rotational oscillation transducers is not well suited for broadband tactile communication. An improved vibro-tactile transducer is therefore needed to make full use of the communication capability of the tactile sense.

### SUMMARY OF THE INVENTION

The roto-oscillator of this invention uses the forces of interaction of the fields produced by rotor permanent magnets with magnetic fields produced by stator current-carrying coils. Electro-dynamic assembly of this invention, on its own, is not capable of producing self-sustained motion, and requires spring linkages to produce roto-oscillation.

In the roto-oscillator of this invention, moving magnets are constrained to the housing and therefore to the stator coils by spring linkages. This system of springs accomplishes three essential objectives: (a) it produces restoring forces when deflected from the neutral position; (b) it maintains an otherwise unstable neutral position corresponding to the optimum torque generation region; and (c) the springs act as a low loss reservoir of potential energy in the exchange with rotational kinetic energy taking place twice during every cycle of oscillation.

An alternating drive current supply connected to the coil windings causes a roto-oscillating motion of the magnet. No commutator is required. Controlling the drive current can continuously and smoothly vary both the amplitude and the frequency of oscillation. As the rotation of the magnet slows down, the kinetic energy associated with magnet motion is transferred to potential energy stored in the springs. After the magnet stops and begins acceleration in the opposite direction of rotation, the kinetic is recovered from potential energy stored in the springs with very little loss. This storage improves the efficiency of the vibro-tactile transducer.

The spring system can be used as an exclusive rotating magnet support eliminating altogether the need for a shaft and bearing. Such a design eliminates the power losses and wears problems associated with bearing friction and lubrication. The design also frees up the center region of the motor, e.g., allowing it to be used for a magnetic flux generating coil or for location of spring linkages.

In the first embodiment of the present invention, a vibro-tactile transducer is energized by a miniature single-phase alternating current (ac) motor. The motor comprises a single coil-driven multi-pole claw tooth stator and a shaft-mounted cylindrical permanent magnet rotor. The motor shaft is constrained by spring linkages in such a way that a shaft's neutral position substantially corresponds to a position of maximum torque generation.

The spring constraint further prevents a shaft rotation from typically exceeding an angle corresponding to the magnetic field alignment of the rotor with the magnetic poles of the stator. The motor shaft roto-oscillates with a frequency and an amplitude substantially determined by the frequency and amplitude of the driving signal applied to the winding.

In this shaft mounted rotor embodiment, the constraint is accomplished by a flat spring attached radially to the shaft. The spring also limits shaft rotation such that the angle of rotation does not exceed an angle corresponding to the pole positions of the motor. The spring further transmits the torque of the motor to a mechanical resonator comprising a plate supported by two flat springs. At the other end the resonator, springs are cantilevered to the vibro-tactile transducer housing. The reaction forces acting on the housing cause the housing to vibrate substantially perpendicular to the supporting skin.

In the second roto-oscillator embodiment of the present invention, a coil-driven multi-pole magnetic structure generates a magnetic field concentrated between pie-shaped extensions. A disk-shaped permanent magnet is supported by torsional springs so that it is located between the pie-shaped extensions. The absence of a shaft and bearing reduces frictional losses, prolongs the life of the device, and reduces the cost of fabrication. Otherwise the requirements for the springs in terms of constraint to the optimum angle, energy storage, and resonance frequency determination are similar to the one in the first embodiment.

Furthermore, the present invention presents a preferred embodiment of roto-oscillator drivers. Such specialized drivers improve the tactile communication performance of roto-oscillators.

Additional aspects and embodiments of the present invention will become apparent to those skilled in the art upon perusal of the following detailed description and accompanying drawings.

### BRIEF DESCRIPTION OF THE DRAWINGS

FIG. 1 is a simplified composite view of a single-phase shaft-mounted actuator;

FIG. 2 is a flattened view of the shaft-mounted actuator showing torque generation;

FIG. 3 illustrates components of torque in a roto-oscillator;

FIG. 4 depicts spring linkages of a shaft-mounted roto-oscillator;

FIG. 5 shows resonance modes in support covers;

FIG. 6 is a view of a shaft-less roto-oscillator;

FIG. 7 is a schematic of a roto-oscillator velocity sensing circuit;

FIG. 8 is a block diagram of a driver using a velocity feedback signal; and

FIG. 9 is a block diagram of a self-resonating driver circuit.

### DESCRIPTION OF THE PREFERRED EMBODIMENTS

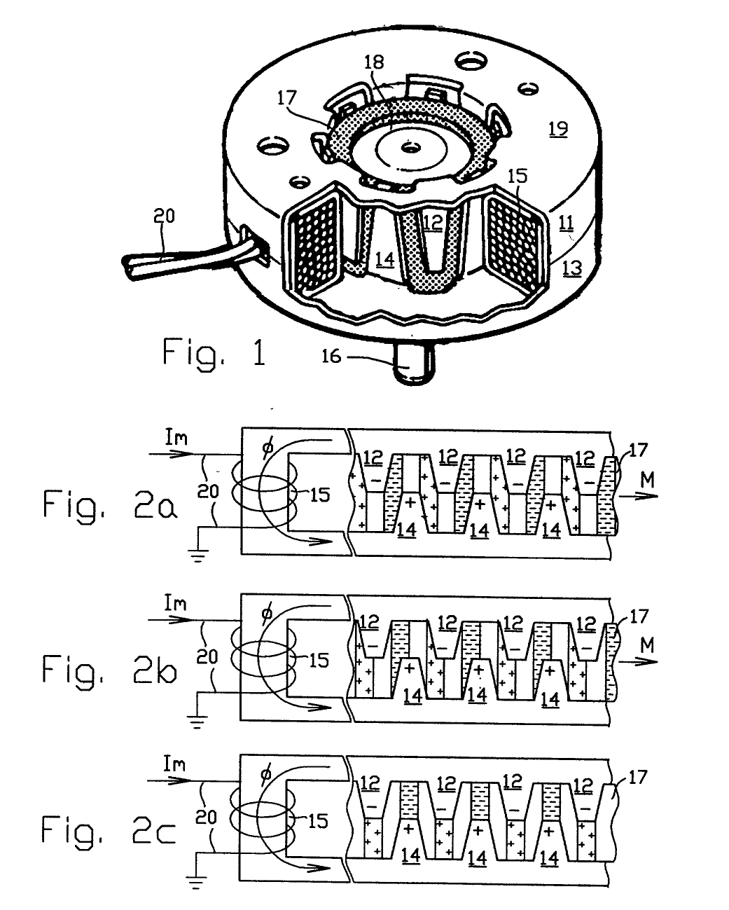

FIG. 1 is a simplified composite view of a single-phase shaft-mounted actuator. This actuator is used in the first preferred embodiment of the roto-oscillator of the present invention as shown later in FIG. 4. A cup-shaped top casing 11 and a bottom casing 13 face each other and are spot-welded together forming a stator enclosure 19. V-shaped claw teeth designated as 12 and 14 respectively are interlaced along an inner diameter of casings 11 and 13. Stator 19 forms a magnetic enclosure for a coil 15. A driving current flowing through coil wires 20 to coil 15 produces a magnetic field between the top claw teeth 12 and the bottom claw teeth 14 so that the claw teeth form current-induced magnetic poles.

The rotor shaft 16 supports a cylindrical shell permanent magnet 17 made from Neodymium-Iron-Boron. Permanent magnet 17 is magnetized along circumferential segments with the same angular pole-to-pole spacing as the claw tooth pole spacing.

Bearings 18 support the rotor shaft 16 against the stator enclosure 19. For clarity, only the top bearings 18 are shown. Elements 11 through 20 comprise the elements of a single-phase motor 10. Motor 10 used in the first preferred embodiment is typically about 10 mm high and 10 mm in diameter and weighs about 4 grams. Ten magnetic poles produce 36° angles between claw-teeth. In operation, the motor typically consumes about 0.1 Watt of electrical input driving power but is capable of as much as 1.5 Watt operation.

Claw-tooth permanent magnet construction is commonly used for low-cost stepper motors. Existing manufacturing techniques and facilities assure that the roto-oscillating motor, of the design described above can be inexpensively fabricated. However, it should be pointed out that the stepper motor and the roto-oscillating motor differ in a fundamental way. A stepper motor has two coil windings driven in phase quadrature located in two separate magnetic enclosures with magnetic poles shifted with respect to each other. Such a two-phase stepper motor configuration creates a rotating magnetic field, designed to achieve a clockwise or anti-clockwise stepped rotation. The single-phase roto-oscillating motor, on the other hand, creates an oscillating magnetic field, which in the present invention is harnessed for a back-and-forth roto-oscillating motion of the rotor shaft 16 but on its own, as will be shown below produces no useful motion.

The electromagnetic interaction between the permanent magnet rotor and the stator current-induced magnetic field in a single-phase motor is shown in FIG. 2. The polarity + (for North pole) or − (for South pole) of induced magnetic poles depends on a direction of the driving current. To make it easier to see, the magnetic structure is flattened with three top claw tooth poles 12 and two bottom poles 14 shown. The effect of the toroidal coil 15 is represented by coil 15 on the left of the figure. The positions of the poles of the permanent magnet 17 are shown by ++ and −− between the claw teeth. The clear region of the rotor represents the interim region. Current Im driving the coil 15 can vary both in magnitude and in polarity; correspondingly changing the magnitude and polarity of the top vs. bottom claw tooth magnetic poles.

In FIG. 2a, a selected direction of current Im through coil 15 generates a magnetic flux φ, resulting in S poles at the top claw teeth 12 and N poles at the bottom claw teeth 14. In

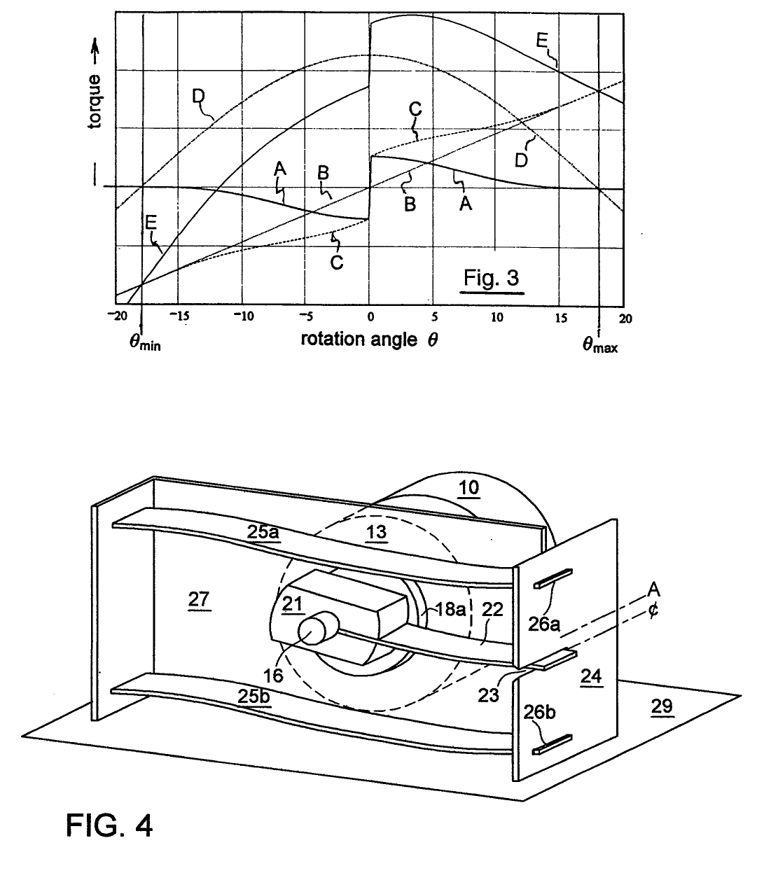

FIG. 2a, the shaft angle is in the interim region of the permanent magnet 17, such that the rotor magnet poles are located halfway between the claw tooth stator poles. As can be seen in graph D of FIG. 3, this angle corresponds to a maximum torque and is designated as an operating position θ=0. The attraction between an opposite polarity rotor pole and the current-induced polarity of the stator's magnetic pole results in rotation to the right, as indicated by arrow M in FIG. 2a, a motion that leads to the rotor position in FIG. 2b. As the rotor motion continues to the right, the opposite polarity rotor and stator magnetic poles line up in FIG. 2c and the torque is reduced to zero at θ=θₘₐₓ. Similar reasoning indicates that an opposite current polarity causes a rotation to the left from the operating position until pole alignment is reached at θ=−θₘₐₓ. The maximum amplitude of rotor oscillation, 2●θₘₐₓ, is therefore determined by the tooth pitch of the motor.

In FIG. 3, graphs of the three basic components of torque in a roto-oscillator and the sums of these components are shown as a function rotor angular position θ. Curve A shows a so-called cogging torque which is always present, even in an un-energized motor. The cogging torque is created by the permanent magnet rotor seeking a shaft position corresponding to a minimum magnetic reluctance of the stator. This torque is discontinuous at the operating position θ=0, with a positive maximum to the right of the operating position and a negative maximum to the left. The shaft position placed at θ=0 is unstable and will move right toward θₘₐₓ or to the left toward −θₘₐₓ. A neutral rotor position, defined as a rotor position with no driving current, therefore corresponds to an alignment of the rotor magnetic poles with a center of the claw teeth at θₘₐₓ or θ−ₘₐₓ. However, the current-induced working torque, represented by curve D, is zero at θₘₐₓ or −θₘₐₓ. A single-phase motor on its own generates no torque.

Some external means are required to keep the initial shaft position stable at or at least near the operating position θ=0. This is accomplished in a roto-oscillator by providing a constraining spring that overcomes the cogging torque so that the neutral position of the shaft is at the initial shaft position. The mechanical configuration that accomplishes this and other objectives is shown in FIG. 4. The net effect of the spring on the single-phase motor is shown in FIG. 3 by line B: The torque vs. shaft rotation angle θ of the spring is depicted. The combined effect of the cogging torque A and the spring torque B is shown by graph C. Graph C has a positive slope throughout indicating that an un-energized rotor has a stable neutral point at θ=0. Graph E in FIG. 3 shows the combine effect of all torques.

The mechanical assembly of the roto-oscillator is shown in FIG. 4. One end of a vane 22 is radially attached to a collar 21 fastened to the rotor shaft 16. The other end of vane 22 passes through a slot 23 in a plate 24. Flat springs 25a and 25b are cantilevered at one end to plate 24 and at the other end to a short arm of an L-shaped bracket 27. Outside diameter of the motor bearing 18a protrudes through a circular hole in the long arm of the L-shaped bracket 27. Flat face of the bottom casing 13 of motor 10 is attached to a long arm of the L-bracket 27.

With no current flowing through the motor coil, the centerline of the slot ∉ is in a position indicated by line A, corresponding to the initial position θ=0 of motor 10. The torque necessary to overcome the cogging torque of motor 10 in order to constrain the motor to the initial position θ=0 is generated by cantilevered springs 25a and 25b and transferred to shaft 16 by vane 22.

In operation, a rotation of shaft 16 deflects vane 22. This deflection causes some bending of the elastic vane 22, as the vane pushes (down in FIG. 4) against the long side of slot 23. This force exerted by the vane 22 causes plate 24 to swing on flat springs 25a and 25b. Plate 24 and the flat springs 25a and 25b form a mechanical resonator driven by vane 22. The ends of springs 25a and 25b transmit a bending moment to the supporting short arm of L-bracket 27. A moment of opposing direction is generated by the reaction of motor 10 support against the long arm of the L-bracket 27. When compliantly supported, the net result is roto-oscillation of the L-bracket and the attached stator of motor 10 in a direction opposing the roto-oscillation of the shaft 16.

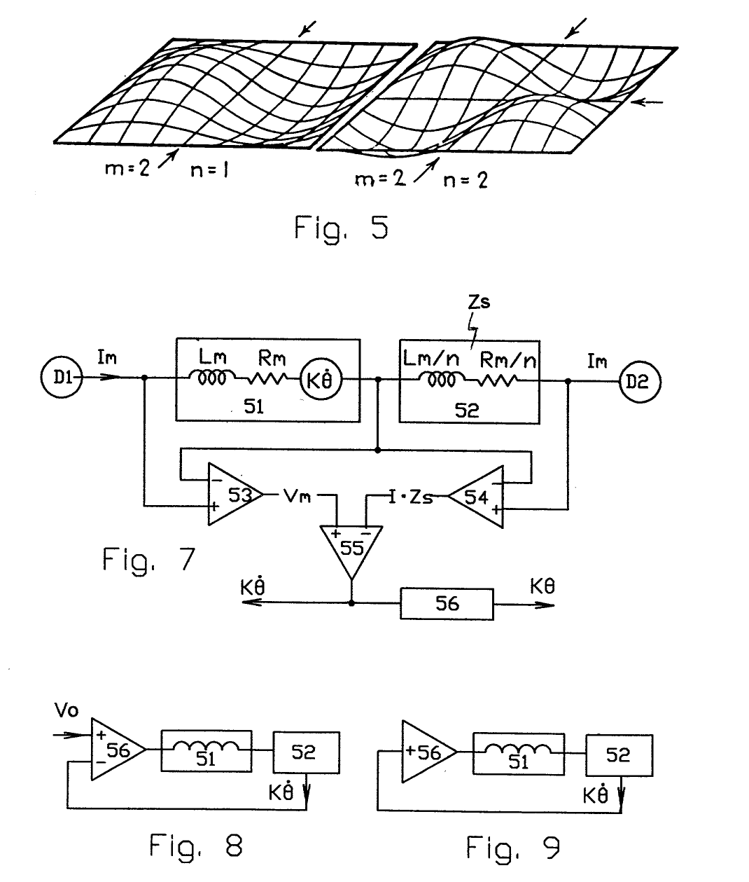

L-bracket 27 is attached to top cover 28 and bottom support covers 29 (only bottom cover 29 is shown). A resonance deflection in a top support cover 28 and a bottom support cover 29 further enhances the vibrotactile stimulus. This is accomplished by choosing thin sheet metal material for the covers of a thickness and size such that the vibration of the L-bracket excites the resonance modes in the covers. FIG. 5 shows resonance modes in support covers. Specifically is shows the m=2\n=1 normal mode on the left and the m=2\n=2 normal mode on the right. Arrows point to nodal lines.

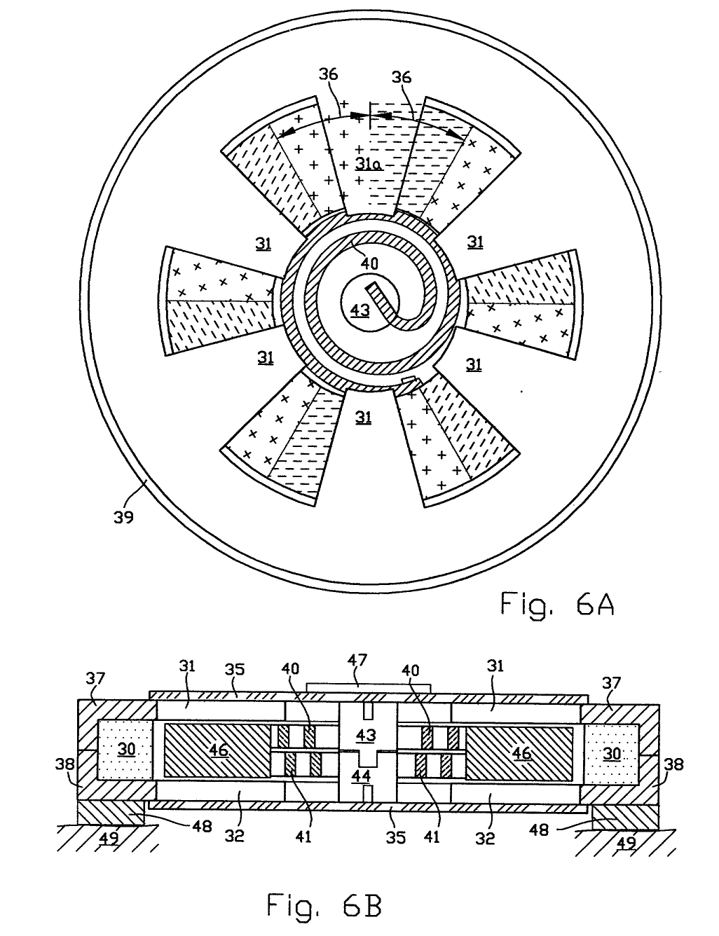

The second preferred embodiment of a roto-oscillator of the present invention is shown in FIG. 6. FIG. 6 A is a top view of this roto-oscillator with a top covering label 35 removed. FIG. 6 B is a cross section view. Coil 30 is placed in the inside periphery of a magnetic circuit formed by the top casing 37 and the bottom 38 casing, made from soft magnetic material. The top casing 37 and the bottom casing 38 are welded at a junction forming a flat cylindrical housing 39.

The top 37 and bottom 38 magnetic casings have petal-like cutouts forming pie-shaped upper 31 magnetic extensions and lower 32 magnetic extensions. The direction of magnetic field between the upper (31) and lower (32) extensions depends on the direction of current in coil 30. This current-induced magnetic field between 31 and 32 interacts with alternate polarity magnetized segments of a disk-shaped permanent magnet 46. A North pole of the permanent magnet is indicated by +++ and south pole by −−−. This polarity is shown only where the permanent magnet is visible except in 31a, which also shows the polarity under the extension. Permanent magnet disk 46 is attached to upper (40) and lower (41) torsional springs wound in the opposite direction, the springs respectively attached to axial posts 43 and 44. The upper spring 40 can be tensioned by rotating post 43 clockwise. Similarly, spring 41 can be tensioned by rotating post 44 counter clockwise. These tensioning adjustments are used to set a desired spring constant and the neutral (unenergized) angular position of the magnet 46. When adjustments are complete, posts 43 and 44 are locked in place.

The adjusted neutral position of magnetized segments 36, as shown in FIG. 6 A, is such that equal magnet surfaces of each magnetic polarity are present under each extension 31. This corresponds to initial angle θ=0 as defined above in connection with FIG. 3. Magnetized segments 36 are shown in more detail under extension 31a. When current flows through the coil, torque is generated to create rotation in the direction of attraction of the magnetic segments 36 and a magnetic field induced by current in coil 30 in extensions 31 and 32. This rotation will continue until the permanent magnet segments 36 line up with extensions 31 and 32. This corresponds to an angular swing equal to the angle subtended by the extension 31 for both polarities of driving current.

A friction ring 48 is attached to the bottom casing 38. In operation, band 47 applies light pressure to the top casing 37 and this pressure holds friction ring 48 against skin 49 causing a torsional vibrotactile stimulus. A very attractive feature of the roto-oscillator implementation of FIG. 6, as compared to FIG. 4, is its form factor. The flat cylindrical housing 39 typically has a radius as small as 10 mm and a height of 4 mm. The flat face of the housing provides a proportionally large contact area with the skin and the low height makes for a very unobtrusive profile. The absence of a shaft and bearing reduces frictional losses, prolongs the life of the device, and reduces the cost of fabrication. A possible, although unlikely disadvantage as compared with the shaft-supported implementation in FIG. 4, is that a shaft-less implementation in FIG. 6 produces a torsional vibrotactile skin stimulus, as compared to the perpendicular skin stimulus of FIG. 4.

A variety of known drivers can be used to operate the roto-oscillators of this invention. If a single power supply, purely sinusoidal operation is desired, one can for example use two linear amplifiers with the roto-oscillator connected between their outputs. Normally non-sinusoidal distortion can be readily tolerated in vibrotactile transducers and in this case a dual full-bridge pulse width modulated driver is a power-efficient solution. Such drivers, fully integrated for low voltage motors, are commercially available.

There are some specialized needs for vibrotactile roto-oscillators that cannot be satisfied by state-of-the-art drivers. In the use for tactile communication, it is clearly desirable to achieve fast information transfer and this in turn requires a fast response time and a broad frequency bandwidth of the roto-oscillators. While roto-oscillators driven by ordinary drivers have a response time and frequency bandwidth superior to many other vibrotactile transducers, these properties can be further improved by applying feedback in an active driver.

What is needed is a driver that senses and controls the roto-oscillator's operational parameters, such as angle of rotation θ and angular velocity θ′, and uses the sensed parameters to maintain control. There are many known ways to sense rotational parameters but to be practical for this application such sensing must not add any transducer hardware or complex signal processing.

The preferred embodiment of an angular velocity sensor is shown in FIG. 7. A diagram in box 51 represents a detailed schematic of the roto-oscillator coil 15 or 30. Lm is the coil inductance, Rm coil resistance, and K the motor constant, so that Kθ′ is the velocity induced voltage and Im is the coil current. Sensing impedance Zs 52 is substantially equal to an n-th fraction of the coil impedance. Coil voltage Vm is sensed by amplifier 53. Voltage across the sensing impedance Zs is amplified n times by amplifier 54. The two are subtracted in amplifier 55 producing an angular velocity output signal Kθ′. Upon integration in integrator 56, the angular position output signal Kθ is derived.

In an active drive, the roto-oscillator current Im is controlled by θ and its derivatives. A preferred embodiment of the active drive is shown in FIG. 8. An error signal is formed by subtracting a value of measured θ′ from a controlling signal Vo and a resulting error signal drives the power amplifier. Such configuration speeds up response time and widens frequency response of the roto-oscillator.

The preferred embodiment driver illustrates the use of negative feedback. Many other useful performance modifications can be reached by applying feedback. For example, a positive feedback circuit in FIG. 9 can provide a self-resonant operation of the roto-oscillator so that only a dc supply is required and the roto-oscillator operates at a resonant frequency of the system regardless of load.

1. A roto-oscillator comprising:
a driver accepting at least one control input and producing an output;
at least one coil producing a magnetic field, said coil connected to the output;
a permanent magnet mounted rotatably with respect to said coil;
spring linkage means for constraining an angular position of the permanent magnet with respect to the coil, such as to substantially optimize a vibratory torque generation in response to said output;
a housing; and
a coupling for transmitting said vibratory torque from the housing to skin whereby causing vibrotactile skin stimulation.

2. The roto-oscillator of claim 1
wherein said coil comprises a stator coil of a single phase motor, when energized, producing a plurality of magnetic poles; and
wherein said permanent magnet comprises a permanent magnet cylindrical shell fastened on a shaft, said shaft rotating in bearings fastened to a stator enclosure said permanent magnet interacting with said plurality of magnetic poles to produce a roto-oscillating torque.

3. The roto-oscillator of claim 2 wherein said housing comprises a bracket rotatably supporting the motor, thereby allowing an initial rotational adjustment of said spring linkage means.

4. The roto-oscillator of claim 3 wherein the housing further comprises a top and a bottom cover attached to said bracket.

5. The roto-oscillator of claim 4 wherein at least one of said top and bottom covers is made to support a resonance mode substantially at a desired vibrotactile frequency.

6. The roto-oscillator of claim 2 wherein said spring linkage means comprises a flat spring, one end of said spring disposed radially with respect to the shaft, a resonator comprising a plate having cutouts and a slot in the center, the other end of said flat spring protruding through said slot and said edges attached by elastic vanes to the housing.

7. The roto-oscillator of claim 1 wherein said coil is placed in an inside periphery of a magnetic circuit formed by casings of soft magnetic material, extending into upper magnetic extensions and lower magnetic extensions, and creating coil current induced magnetic field between the extensions.

8. The roto-oscillator of claim 1 wherein said permanent magnet comprises a permanent magnet annular disk magnetized in segments of opposite magnetic polarity, said disk supported on its periphery by springs in a manner that allows said disk to roto-oscillate with respect to the housing.

9. The roto-oscillator of claim 1 wherein said spring linkage means comprises a torsional spring coupling the permanent magnet and the housing.

10. The roto-oscillator of claim 1 wherein the coupling for transmitting said vibratory torque from the housing to the skin comprises a band pressing lightly on the top cover against the bottom cover resting against the skin thereby reactively transmitting a vibration of a vibrating mass through the bottom cover to the skin.

11. A method of producing a controlled vibrotactile stimulus, which comprises
applying at least one control signal to a driver;
connecting the driver to a stator coil configuration producing a current—induced magnetic field;
placing a permanent magnet in the current -induced magnetic field so as to produce roto-oscillation of the magnet;
coupling the roto-oscillation of the magnet to a spring linkage that maintains a substantially optimal angle for torque generation, produces roto-oscillation at a desired frequency, limits amplitude of angular oscillation, and converts angular oscillation into vibration of a housing; and
coupling the vibration of the housing to skin, whereby producing a controlled vibrotactile stimulus.

12. A method of producing a controlled vibrotactile stimulus as recited in claim 11 wherein the step of connecting the driver to the stator coil is accomplished through a sampling impedance, a value of said sampling impedance being a fraction of coil impedance.

13. The roto-oscillator as recited in claim 12 comprising further steps of
measuring voltage across said sampling impedance;
measuring voltage across the coil; and
processing and comparing the above said voltages to derive a signal proportional to angular velocity of roto-oscillation.

14. The roto-oscillator as recited in claim 13 comprising further steps of
comparing the angular velocity signal and an input signal representing a desired value of angular velocity to generate an error signal; and
applying the error signal as a driver control signal.

15. The roto-oscillator as recited in claim 12 comprising further steps of
measuring voltage across said sampling impedance; and
application of a signal derived from this voltage as a positive feedback signal to the driver in a manner causing a self-resonance of the roto-oscillator.
